(19) United States
(12) Patent Application Publication
(10) Pub. No.: US 2009/0008472 A1
(43) Pub. Date: Jan. 8, 2009

(54) Control Devices For Irrigation Systems And Methods For Programming

(76) Inventor: Chadwick Loring Wilson, Woods Cross, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/772,699

(22) Filed: Jul. 2, 2007

(51) Int. Cl. B67D 5/08

(52) U.S. Cl. 239/71

(57) ABSTRACT

Control devices and the associated methods for programming and using such devices for irrigation systems are described. The control devices contain an interactive user interface that allows a step-through programming method that can be initiated upon first use or reset of the control device. The user interface is simple and easily understood and be easily toggled between one part of the programming and any other part, allowing immediate modification of any part of the program. The user interface also contains quick set options in the user interface. The control devices therefore have a gentle learning curve and the programming is simple and easily navigated.

### FIELD

The present application relates, in general, to control devices for irrigation systems. In particular, the present application relates to controlling devices and associated methods for making and using such devices for controlling sprinkling systems and other types of irrigation systems.

### BACKGROUND

The use of irrigation systems in yards, small farms, and greenhouses is widely accepted for distribution of liquid, including water and sometimes chemical additives, to a specified area (usually containing plants and grass). One type of irrigation system, a sprinkling system, receives the liquid from a liquid source and distributes the liquid to various types of sprinklers containing sprinkler heads. The sprinkler heads in turn distribute the liquid to the plants and grass in the specified area with the minimum amount of liquid needed, while also providing proper coverage of the entire area. As the volumetric pressure from the liquid source is usually limited, several zones are generally established and the liquid distribution is rotated between the zones so that sufficient pressure for distribution is always present at each sprinkler head.

In some instances, each zone can be manually operated by turning on a valve that allows sufficient flow of the liquid to that zone. In other words, an individual manually needs to decide the time needed for proper distribution of the liquid to a specific zone and operate the valves as necessary. These zone systems for irrigation can, therefore, require a large amount of manual labor and time for proper operation. And since they operate manually, they can not be used when the operator is not present, i.e., they can not be used in a home when the home owner is on vacation.

In other instances, though, the irrigation zones may have a centralized location where valves for each zone may located and controlled. These configurations reduce or eliminate the need for manual operation of zones because an electromechanical control system can be used at the centralized location. The control system uses electrical wires that control the opening and closing of the valves. The electrical wires are connected to a timer that may be located at the centralized location or at a remote location, such the exterior of a wall (often fairly near to the centralized), or in a building so as to not be visually obtrusive.

While the timer devices partially automate the irrigation process, such timers typically have a limited flexibility and operability. With all of these timing devices, programming the timer has a fairly steep learning curve such that when the system is programmed, the user is often left wondering what he did and how he can modify his program when desired. This is often the case because the programming method rarely shows the whole program and when it does the program is cryptic and not easily navigated.

### SUMMARY

The present application relates to control devices and the associated methods for programming and using such devices for irrigation systems. The control devices contain an interactive user interface that allows a step-through programming method that can be initiated upon first use or reset of the control device. The user interface is simple and easily understood and be easily toggled between one part of the programming and any other part, allowing immediate modification of any part of the program. The user interface also contains quick set options in the user interface. The control devices therefore have a gentle learning curve and the programming is simple and easily navigated.

### BRIEF DESCRIPTION OF THE DRAWINGS

The following description can be better understood in light of Figures, in which:

FIG. 1 illustrates one example of control device;

FIG. 2 depicts one example of a programming method;

FIGS. 3-10 illustrate different version of user interfaces presented in connection with the programming method depicted in FIG. 2; and

FIG. 11 depict a main user interface for the control device.

Together with the following description, the Figures demonstrate and explain the principles of the control devices and the associated methods for making and using such devices to control irrigation systems. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that the devices and associated methods of programming and using the timing devices can be implemented and used without employing these specific details. Indeed, the devices and associated programming methods can be placed into practice by modifying the illustrated devices and can be used in conjunction with any devices and techniques conventionally used in the industry. For example, while the description below focuses on control device used to control a sprinkling system in a residential yard, these devices may be implemented in many other applications and end uses, such as controlling the kinds and amounts of chemical additives, controlling non-sprinkling systems, or controlling irrigation systems for an arbor or a greenhouse.

The control devices are used to control the operation of valves used in an irrigation system, such a valves used to operate a plurality of watering zones in a residential sprinkling system. Typically, the control devices are mounted to a fixed location, such as externally on a home exterior (such as a utility panel) near the valves (i.e., so the valves may be manually overridden while standing near the control device). Alternatively, the control devices can be placed remote from the valves in a garage or basement of a home. Indeed, the control devices can be mounted to any desired location.

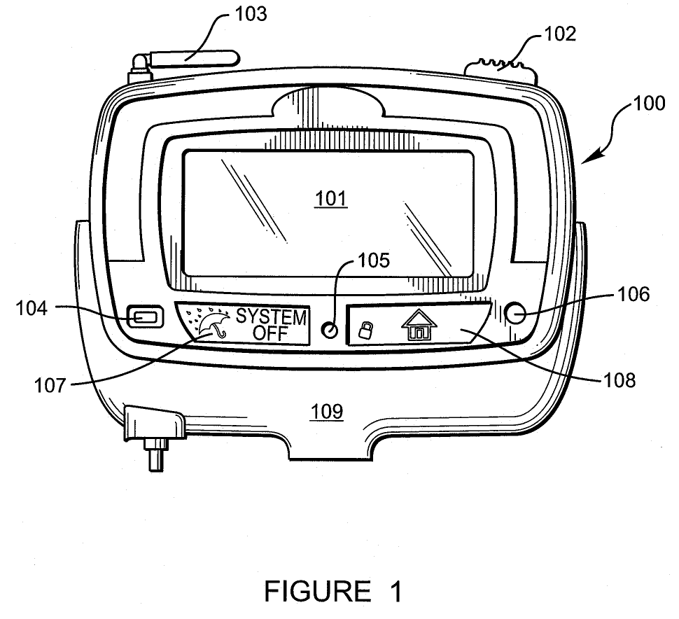

The control devices of the invention contain a timing device (or timer) that controls the valves for irrigation zones. FIG. 1 illustrates one view of the timing device the can be used in the control devices. The timer 100 contains a control program that determines start, stop, running durations, and other parameters for one or more watering or irrigation zones and correspondingly sends electrical control signals to control corresponding valves that allow water to irrigate each programmed zone. The timing device comprises multiple programming features that enhance the ability of a user to control and re-write the control program, described in detail below.

The timing device 100 may contain a memory device, such as an EEPROM module (not shown) that embodies the control program for the sprinkling system. Thus, the control program will not be lost in the event of a complete power failure to the timing device. The timing device is also comprised of a screen 101 for viewing the control program. The screen 101 may be any type of display screen as known in the art, including an LCD screen as shown, that allows for touch screen interaction by the user of the timing device.

The screen 101 may be controlled via any suitable mechanism known in the art. One example of control mechanism comprises a pointing device, such as stylus 102. The stylus may be conveniently stored out of view in a holder found on the timer's housing. The stylus 102 (or a finger) may be used to navigate the LCD screen to view and interact with the control program.

In some embodiments, the timer 100 may contain a radio frequency (“RF”) receiver and RF antennae 103, a USB port (not shown), a precipitation sensor 104, a reset button 105, a RF synchronization button 106, an override control 107, and a screen lock feature 108. In other embodiments, the timer 100 can contain any other components that help it operate in the manner described herein.

The RF receiver and antennae 103, along with the USB port, provide for numerous ways of programming the timer 100 remotely. With the RF receiver and RF antennae, a user may carry a separate programming device (containing an RF transmitter) that can synchronize to the timer through the RF synchronization sensor 106 and later transmit programming instructions via RF transmission to the timing device. This configuration allows the user to program the timer remotely so that the user can be on location with the various valves and their corresponding watering zones, or even at an individual sprinkler. Alternatively, a user can program from a personal computer (“PC”) or other computing system (such as a portable computing device like a laptop PC or any type of personal digital assistant, or even a properly-configured cellular telephone) that has an interface with the timer 100. In this configuration, the USB port (not shown) may be connected to the PC using any known wired technologies, such as Ethernet, or any known wireless technologies, such as 802.11 standards. In another configuration, the programming could be performed remotely and then uploaded by using a flash drive.

The precipitation sensor 104 in the timer can be used to sense precipitation as known in the art. In some instances, the precipitation can be sensed directly if the timer (that contains the sensor 104) is mounted near the irrigation zone valves. In other instances, the precipitation can be sensed indirectly by using a remote sensor and sending the signal from the remote sensor to the timer using any known wired or wireless technology. The precipitation sensor, whether located in the timer or located in a remote sensor, allows the control device containing the timer to control the valves and stop the irrigation if precipitation reaches a predetermined level for a predetermined duration. Alternatively, since the timing device can be connected to a PC or similar device described above (and using the PC, to information data sources such as the internet), the timing device could utilize precipitation information from a local, regional or other registry (including the national weather service) and utilize that information from these databases to control the timing device as needed.

The timer 100 can also contain a reset mechanism, such as reset button 105. The reset mechanism may be used for setting the timing device back to factory settings should it become non responsive or over programmed. The timer can also contain an override mechanism for the control program, such as program override button 107. The override mechanism can be used to terminate the control program during a sudden storm, tornado, or other severe weather pattern (including a drought) where interrupting or overriding the control program is needed or is required by local authorities. The override mechanism could be set with any desired parameters, for example, to require restarting the control program manually or to terminate the interruption and return to normal programming after a certain delay period (such as a twenty-four hour latency period to accommodate forgetful users).

To prevent accidental reprogramming, the timer can contain a locking mechanism, such as a system or screen lock 108. The locking mechanism provides easy access to the control program of the timer while simultaneously preventing the screen 101 from being accidentally triggered to reprogram or terminate active programming. Optionally, the locking mechanism may also function as a home navigating button to quickly help the user navigate to the main program screen.

The timer 100 can be connected to any known mounting assembly. The mounting assembly fixes the timer to a specific location (such as a wall) and thereby makes the timer easier to use and highly visible. The mounting assembly and the timer can be designed to be connected to a docking station that is in electronic communication with the valves of irrigation system as known in the art. The mounting assembly and the docking station allow the timer to be removed and remotely program. One example of a mounting assembly and the docking station, as well as methods for removing the timer so it can be remote programmed, that can be used is disclosed in the co-pending U.S. patent application Ser. No. ______ (Attorney Docket No. 8728.014) entitled “Control Devices For Irrigation Systems,” filed concurrently herewith and the disclosure of which is incorporated herein by reference.

In some embodiments, such as when the timer is initially powered on or when it is reset, the timer may need to be programmed by the user. The timer contains several features in the user interface (UI) that makes this initial programming quick and easy. First, the timer contains a series of quick set options. Second, the timer sequentially proceeds through the programming options, quickly educating a user as to the timer's functionality and ease of use, while also guiding a user's programming. And the timer also contains toggle options that allow a user to switch easily between the current programming option and the rest of the programming sequence. These features allow a user to immediately access the desired functionality, while simultaneously allowing a user to modify the programming at any time from the home menu of the UI.

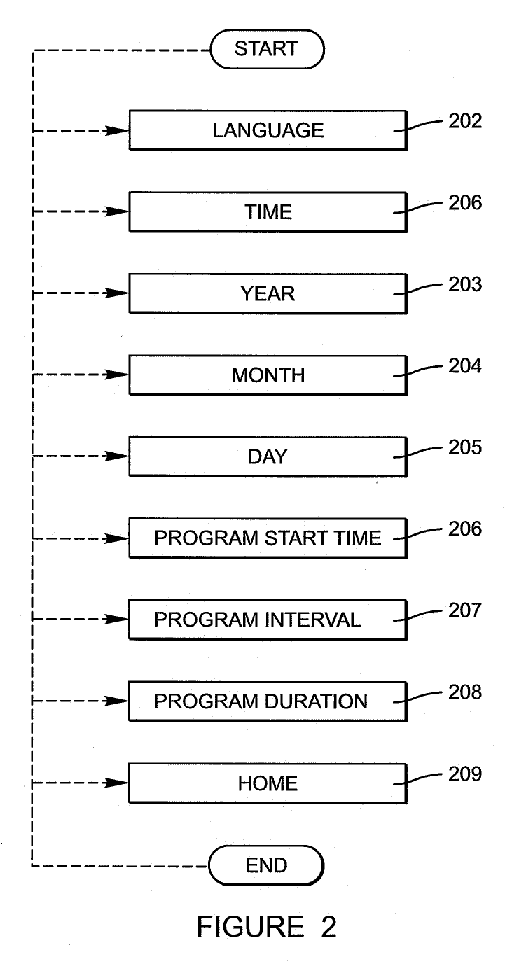

FIG. 2 shows a flowchart of one example of an initial or reset programming method for the timer. It should be noted that although the exemplary method in FIG. 2 will be discussed in successive steps, it may be done in alternate orders and should not be understood as having to be performed in the described order. A method of fewer or more steps than those depicted may also be used. At each part of the method illustrated in FIG. 2, the timer may contain defaults have been pre-established (such as when it is manufactured), allowing a user to select that default setting.

The method begins at block 200 when it is started, for example, when the user powers on the timer or presses the reset button 105. Of course, the programming method can also be started when the user desires to re-program the timer.

After being started, the programming method proceeds through a series of questions or queries which require limited, if any, user input. The programming method requires limited user interaction so that the method is easy and simple for any user to understand and follow. The questions are sequentially presented for the user's input into the timer until all queries have been answered, at which point the programming methods sends the user to a main (or home) menu or screen at the end of the method. Alternatively, as illustrated in FIG. 2 by the dotted lines, the user can quickly return to any previous part of the programming method.

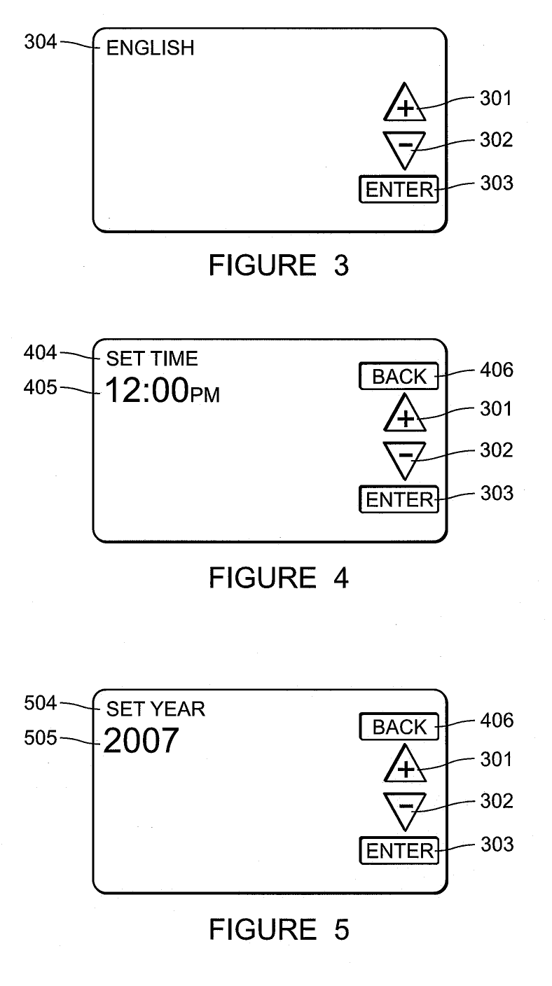

The first query or part of the programming method is presented in block 201 where the user is asked for the language. The default language can be pre-set according to the expected locale in which the timer will be sold. An exemplary user interface (UI) presented to the user during the query in block 201 is depicted in FIG. 3. Any known selection menu to select among the various language options can be used when selecting the language. In some embodiments, the selection menu comprises an up scroll button 301 indicated both pictorially with an upward facing triangle and symbolically with a “+” sign. Similarly, a down scroll button 302 is indicated with a downward facing triangle and a “−” sign. During the selection, the user has 3 simple options, all of which are easily understood. The user may scroll up through a list of languages by using the up scroll button 301, down through the list of languages by using the down scroll button 302, or accept the language displayed by pressing the “enter” button 303. The selected option for this part of the programming method (here, language 304) can be shown anywhere on the UI, but typically is shown in the upper left hand portion.

Once the language has been selected, the programming method then proceeds to the next query where the user can select the time, as shown in block 202. An exemplary user interface (UI) presented to the user during the query in block 202 is depicted in FIG. 4. Any known selection menu to select among the various timing options can be used when selecting the time. Again, the user may scroll the time up using the up scroll button 301 or scroll the time down using the down scroll button 302. As shown in FIG. 4, the current programming task (here, to set the time 404) has been added to the user interface for convenience of the user. And the selected option (the actual time 405) can also be displayed. Since the programming method has progressed beyond the first selection (i.e., language), a new selection is added to the user interface (back option 406) so the user may go back (if desired) to the previous programming option(s). Once the time has been selected, the user again presses enter to continue the programming method.

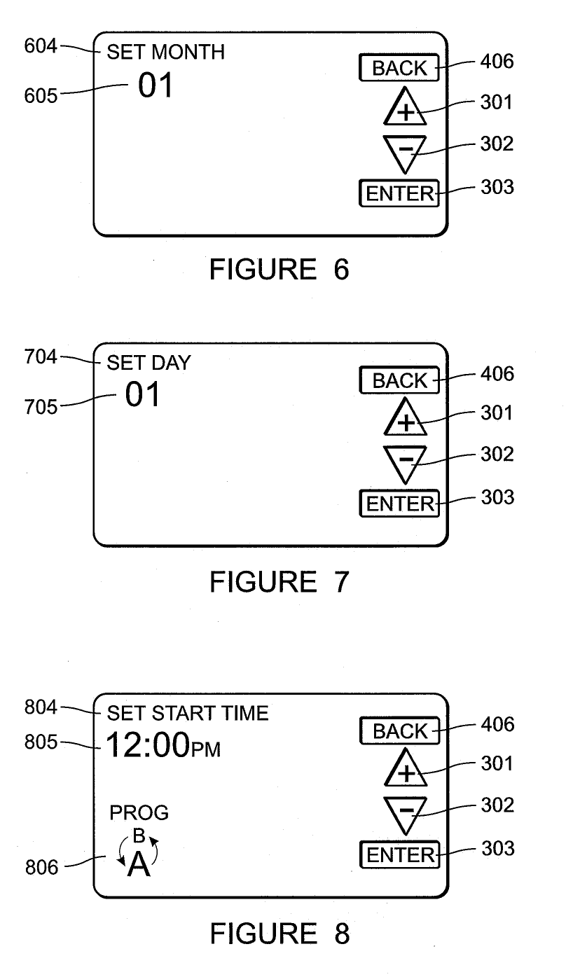

The next 3 parts of the programming method proceed in a similar fashion, but the selection criteria are different. Rather than selecting the time in block 202, the user selects the year in block 203, the month in block 204, and the day in block 205. The UI for selecting the year is depicted in FIG. 5 which contains substantially similar features as FIG. 4, except the option is now the year instead of the time. The UI for selecting the month is depicted in FIG. 6 which contains substantially similar features as FIG. 4, except the option is now the month instead of the time. And the UI for selecting the day is depicted in FIG. 7 which contains substantially similar features as FIG. 4, except the option is now the day instead of the time. While each of these UIs contain numeric connotations for the day/month/year, other conventions could be utilized, including names or symbols instead of numbers. Again, to complete each selection, the user simply presses the up scroll button 301 or down scroll button 302 to change the programmed query, presses the back option 406 to go back to a previous selection in the programming method, and enter to accept the displayed selection.

Upon finishing the language and calendar settings (date and time) in blocks 201, 202, 203, 204, 205, the user is prompted to begin the part of the programming method to set up the control of the irrigation process itself. In block 206, along with the UI shown in FIG. 8, the user is prompted to select a start time for the irrigation process. The UI in FIG. 8 contains similar features (scroll buttons 301 & 302, back button 406, task button 804, and selected option button 805) as already discussed and they may be operated in a similar manner.

The UI in FIG. 8 also contains a toggle button 806. The toggle button 806 operates to switch (or toggle) between an active portion and any inactive portion of the programming. In some embodiments, two portions of the programming are shown with the active portion displayed with a large letter “A” and one inactive portion shown with a small letter “B” above it. Arrows are used to indicate what portion will come into an active mode when the toggle button 806 is touched.

While FIG. 8 shows only two portions of the program between which to switch, more inactive portions could be incorporated into the toggle button 806 as an option to be selected. In these embodiments, the plurality of inactive portions could be shown in the small letter section each with a different letter (or number) with the order shown according to their placement and the active portion still shown in larger lettering. As an example, a user may choose to program the A portion for watering on odd days in the morning, the B portion for evening watering every three days, and then a C portion for watering every night. In this example, the user could set the start time 805 to 6:00 am for the A program, then press the toggle button 806 to set the evening start time 805 to 5:30 pm for the B program, and then press the toggle button 806 to set the night start time for 11:30 pm. Although the user may set all of the active and inactive programs at this point, the programming method does not require him to set them and they may default to only a single program at a single time. Thus, the UI in illustrated in FIG. 8 captures a complex idea in watering times and dates, and then depicts it simply for the user to understand.

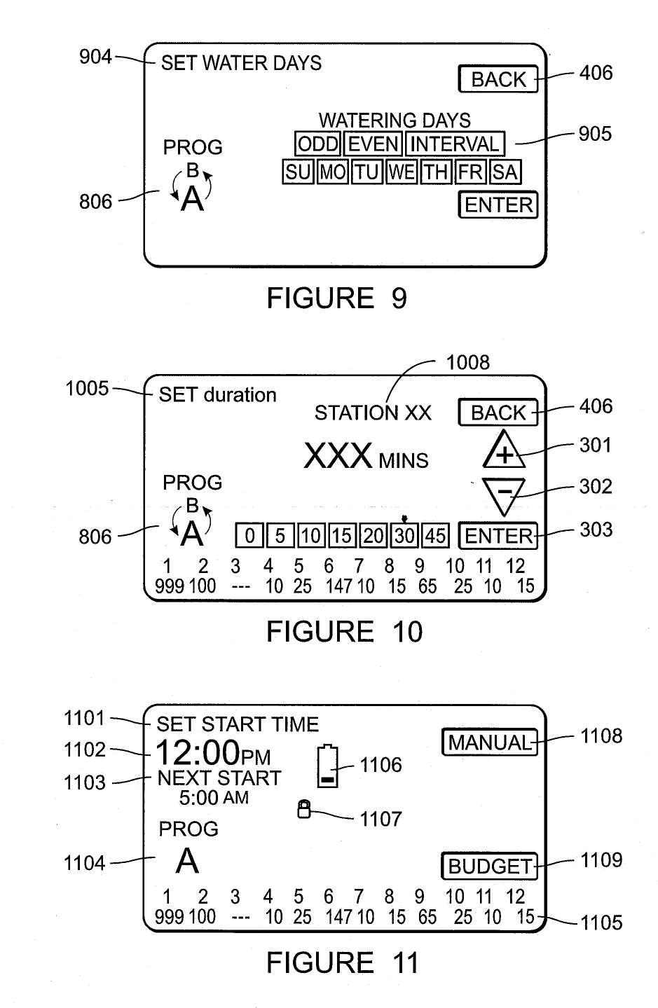

The programming method then proceeds to ask the user for the days the irrigation system should run, as depicted in box 207. The UI presented to the user during this procedure is shown in FIG. 9. As discussed previously, the user may choose the days for any of the programs or none at all. If no interval is selected, a default interval such as daily may be utilized. The user may select any pre-programmed intervals such as odd days, even days, or any single day of the week. Alternatively, the user may select his own interval by selecting the interval button and using the scroll buttons on an interval screen (not shown). The interval could be in any time period, such as hours, days or months. Again, the toggle button 806 can be incorporated into the UI so that the user may choose to water every day for the “A” or morning program and every third day for the “B” or evening program by simply selecting their corresponding intervals while the program toggle button is selected.

The programming method continues when the user is prompted, as shown in block 208, to select the duration(s) for each irrigation station. The UI presented to the user during this procedure is shown in FIG. 10. Again a default option may be utilized, such as watering each station for 10 minutes. In this UI, a station indicator 1008 shows the station (or zone) the user wishes to program and a duration indicator 1005 for easily seeing the duration selected for the indicated station. As before, the user may use the program toggle button 806, select a station from a plurality of stations by pressing the station's indicator on the bottom of the screen 1007, and then selecting a default duration from pre-defined time buttons 1006 or using the up and down scroll buttons to select a specific time for each zone. Upon finishing the desired duration entries for each zone, the user presses the enter button.

Upon finishing this programming method, the timer goes to the UI shown in FIG. 11, also called a main menu or home screen. The home screen may be set to lock automatically after a certain time of no user interaction. To unlock the screen, the user need only push the lock screen/home button 108 and the screen and its programming functions can then be fully accessible. From the main menu, the user may choose to modify any previously programmed elements simply by pressing the corresponding indicator. To set the time, for instance, the user need only select the set time screen and it will be displayed without the back button 406 since the initial programming has already been completed and the user only needs to re-program the time.

Similarly, the user may go to any of the corresponding screens by simply pressing the appropriate indicator. For example, the program duration and intervals can be re-set by pressing the program button 1104 and a station and interval programming screen appears that now shows interval elements from both the set water days screen as seen in FIG. 9 and the set duration elements from the elements screen as seen in FIG. 10. Again, the user may toggle between programs, as well as program any desired aspect of the program, simply by selecting the appropriate part of the UI.

In some instances, the home screen can display the command to be taken. Accordingly, it displays the current running program, if still not completed, or shows the next program to run if no programs are active. The UI also shows the current date 1101, the current time 1102, the start time for the next program 1103, the active or next program the timer will execute 1104, and the duration for each station in the program 1105. Along with these options, the UI can contain other features such as a battery indicator 1106, a screen lock indicator 1107, or the like.

The home screen also contains two features not described above, the manual programming option 1108 and the global programming option 1109. The manual programming button 1108 takes the user through a minimal programming sequence to manually program the desired aspect of the timer. The user may choose to just run each of the zones for a pre-defined interval, like 5 minutes, or he may force each program to run through or may choose any other manual override such as programming one zone to run so he may fix sprinkler heads in one zone at a time.

The global programming button 1109 brings up a simple interface that allows the user to increase the running durations during a drought or other watering event requiring a temporary change. The simple screen allows the user to use the scroll buttons to run the durations above or below 100% of the programmed times. For instance if all zones are set to run for 10 minutes, running the program at 150% would increase their running times to 15 minutes for each zone. One of the most common interruptions to an irrigation timer is when a rainstorm occurs or precipitation hits above a certain level. The global programming button allows for these interruptions by providing a manual programming element rain button 107 that takes the user to a simple screen asking how long the timer should be off before resuming. Again the duration could be in any increment, such as hours, days or months. The global programming option can be integrated to automatically work with sensors activated by active/deactivate switch 104 (which interrupt the program when the sensor indicates precipitation at a certain level or other method of precipitation measurement is established through the sensor interfaces).

In some embodiments, once the programming method in FIG. 2 begins, it must be completely finished before the home screen (which allows manual programming) becomes enabled, even if the user only selects each default option presented. If the user chooses not to finish the initial programming method by not completing any part of the process illustrated in FIG. 2, the timer will go to the home screen. But any attempt to access the home screen functionality will simply take the user back to that part of the initial programming method where the user stopped, thereby forcing the user to complete the initial programming method.

In other embodiments, though, the timer can be configured so parts of the initial programming method can be skipped before the home screen can be accessed by the user. In these embodiments, the user can select those potions of the initial programming method to skip and return to at a later date to complete.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

We claim:

1. A control device for an irrigation system, comprising:
a timer connected to a plurality of irrigation valves, the timer containing an interactive display screen with a plurality of interactive programming elements, the plurality of irrigation valves being controlled by the interactive programming elements which are capable of setting any given function for the irrigation valves with a single selection by a user.

2. The control device of claim 1, wherein the timer is capable of toggling between a given programming element and another programming element by a single selection by a user.

3. The control device of claim 1, wherein the interactive programming elements allow a user to program the timer by sequential selection of each function of the irrigation valves.

4. The control device of claim 1, wherein the interactive programming elements allow a user to program the timer by non-sequential selection of any given function of the irrigation valves.

5. The control device of claim 1, further comprising an override for interrupting the timer.

6. The control device of claim 1, further comprising a precipitation sensor activation switch for allowing overriding of the programming when precipitation reaches a predetermined level.

7. The control device of claim 1, further comprising a screen lock for preventing accidental programming of the programmable timer.

8. The control device of claim 1, wherein the interactive display screen is an LCD screen.

9. The control device of claim 1, wherein each interactive programming element can program a given function of the plurality of valves.

10. The control device of claim 1, wherein the interactive programming elements allow programming of a current date and a current time.

11. The control device of claim 9, wherein the interactive programming elements allow programming of a start time, a duration of irrigation, and a day or days of irrigation, any of which can be programmed by a single selection of the respective programming element.

12. A timer for an irrigation system, comprising:
a timer connected to a plurality of irrigation valves, the timer containing an interactive display screen with a plurality of interactive programming elements, the irrigation valves being controlled by the interactive programming elements which are capable of setting any given function for the irrigation valves with a single selection by a user and the interactive programming elements allow a user to program the timer by sequential selection of each function of the irrigation valves.

13. The timer of claim 12, wherein the timer is capable of toggling between a given programming element and another programming element by a single selection by a user.

14. The timer of claim 12, wherein each interactive programming element programs a given function of the valves.

15. The timer of claim 14, wherein the interactive programming elements allow programming of a start time, a duration of irrigation, and a day or days of irrigation, any of which can be programmed with a single selection of the respective programming element.

16. The timer of claim 15, wherein the interactive display screen is an LCD screen.

17. An irrigation system containing a timer, the timer connected to a plurality of irrigation valves, the timer containing an interactive display screen with a plurality of interactive programming elements, the irrigation valves being controlled by the interactive programming elements which are capable of setting any given function for the irrigation valves with a single selection by a user and the interactive programming elements allow a user to program the timer by sequential selection of each function of the irrigation valves.

18. The irrigation system of claim 17, wherein the interactive display screen is an LCD screen.

19. The irrigation system of claim 17, wherein each interactive programming element of the timer programs a given function of the valves.

20. The irrigation system of claim 17, wherein the interactive programming elements allow programming of a start time, a duration of irrigation, and a day or days of irrigation, any of which can be programmed with a single selection of the respective programming element.

21. A method for irrigating, comprising:
connecting a timer to a plurality of irrigation valves, the timer containing an interactive display screen with a plurality of interactive programming elements, the irrigation valves being controlled by the interactive programming elements which are capable of setting any given function for the irrigation valves with a single selection by a user and the interactive programming elements allow a user to program the timer by sequential selection of each function of the irrigation valves; and
interacting with the timer to program the irrigation valves.

22. The method of claim 21, wherein each interactive programming element of the timer can program a given function of the valves.

23. The method of claim 21, including interacting with the programming elements to program a current date, a current time, a start time, a duration of irrigation, or a day or days of irrigation by a single selection of the respective programming element.

24. The method of claim 21, wherein the interactive display screen is an LCD screen.
